(19) United States
(12) Patent Application Publication
(10) Pub. No.: US 2023/0080412 A1
(43) Pub. Date: Mar. 16, 2023

(54) Method for Inductive Surface Layer Hardening

(71) Applicant: SMS Elotherm GmbH, Remscheid (DE)

(72) Inventors: Stefan Dappen, Koeln (DE); Michael Dawidowicz, Solingen (DE)

(21) Appl. No.: 17/798,329

(22) PCT Filed: Feb. 10, 2021
(86) PCT No.: PCT/EP2021/053177

§ 371 Date: Aug. 9, 2022

(30) Foreign Application Priority Data
Feb. 10, 2020 (DE) 10 2020 103 299.4

(51) Int. Cl. C21D 1/18; H05B 6/10; H05B 6/44; C21D 1/10

(52) U.S. Cl. CPC C21D 1/18; H05B 6/102; H05B 6/44; C21D 1/10

(57) ABSTRACT

The invention relates to a method for the inductive surface layer hardening of a surface which runs around an annular component and has an initial zone, an end zone and two intermediate zones extending between the initial zone and the end zone. The initial zone is brought to hardening temperature by an inductor and quenched by a spray. Subsequently, an inductor arrangement is moved in each case along the intermediate zone to the end zone. Each inductor arrangement includes a leading inductor for preheating the region covered by it, a trailing inductor for finish-heating the preheated region and a spray for quenching the finish-heated region. After the inductor arrangements are located at a certain distance from the initial zone, the leading inductor of at least one of the inductor arrangements is moved in the direction of the end zone at an increased feed rate compared to the trailing inductor. The leading inductor thus reaches the end zone by a time interval earlier, whose duration is equal to the duration required by the trailing inductor to overcome the distance previously resulted between said trailing inductor and the leading inductor. In the meantime, the end zone is preheated by the leading inductor that reached it. When one of the trailing inductors of the inductor arrangements has arrived in the end zone, it heats the end zone to the finished hardening temperature.

### CROSS-REFERENCE TO RELATED APPLICATIONS

This application is the United States national phase of International Application No. PCT/EP2021/053177 filed Feb. 10, 2021, and claims priority to German Patent Application No. 10 2020 103 299.4 filed Feb. 10, 2020, the disclosures of which are hereby incorporated by reference in their entirety.

### BACKGROUND OF THE INVENTION

### Field of the Invention

The invention relates to a method for the inductive surface layer hardening of a surface which runs around an annular component consisting of a hardenable steel.

### Description of Related Art

“Methods for the inductive hardening of a surface layer” are methods in which the surface layer of the steel material which adjoins the surface to be hardened in each case and of which the component carrying the surface in each case consists, is heated to hardening temperature by means of an electromagnetic field induced in the component and in which the section of the surface layer heated in this way is subsequently cooled down sufficiently quickly by applying a suitable quenching medium in order to generate hardening structures in the relevant surface section.

The technical and physical backgrounds of inductive surface layer hardening are explained in Data Sheet 236, “Heat treatment of steel—Surface layer hardening”, 2009 Edition, which is published by the Wirtschaftsvereinigung Stahl, Sohnstraße 65, 40237 Düsseldorf, and is available for download under the URL https://www.stahl-online.de/wp-content/uploads/2019/04/MB236_Waermebehandlung_von_Stahl_Randschichthaerten. pdf, Date retrieved, 6 Feb. 2020.

The annular components on which surfaces can be surface layer hardened by means of the method according to the invention are typically bearing rings for large-size rolling bearings or similar. Such bearing rings are used, for example, for the rolling bearings in which the rotors of large wind turbines are mounted or for rolling bearings in which tower cranes and the like are rotatably mounted about a vertical axis. The diameters of such bearings are typically in the range of 40-1000 cm.

Circumferential surfaces of such large annular components can be particularly effectively surface layer hardened by using two inductors, which are moved in synchronous, counter-rotating movements along the surface to be hardened. In this way, the inductors successively heat to hardening temperature the surface section covered by the electromagnetic field they generate. The surface sections heated in this way are then quenched by spray jets, which are each applied by a spray tracking the inductors.

The advantages of this type of surface layer hardening are offset by the fact that the two or more inductors can only be approximated to one another up to a certain distance due to the installation space taken up by them. In this way, even if the inductors are arranged very closely adjacent to one another at the beginning or end of the machining process, a zone remains on the workpiece in which only insufficient hardness is achieved, because the electromagnetic fields generated by the inductors do not directly reach the zone of the surface to be hardened present between the inductors or because only insufficient heating of this zone occurs due to mutual disturbances of the fields generated by the inductors. In practice, the initial zone of the surface to be hardened, over which the inductors are situated closely adjacent at the beginning of the hardening process, proves to be less problematic than the end zone, since during the heating of the initial zone, a previously heated surface section does not have to be quenched at the same time and sufficient time is therefore available to bring the region not directly covered by the electromagnetic fields of the inductors to the hardening temperature by means of heat migration.

However, without any special countermeasures and due to the structural conditions, a region remains in the end zone of the surface to be hardened, in which the inductors meet again after they have been moved along the ring sections assigned to them in each case, which is only insufficiently heated and therefore does not reach the hardness achieved over the remaining sections of the surface to be surface layer hardened. This only incompletely hardened region is also referred to in technical terms as “slip” and can lead to premature failure in practical use, in particular in applications in which the surface layer hardened surfaces are regularly loaded over their entire circumference. As a result, the slip region wears more quickly than the rest of the higher-hardened region of the surface layer hardened surface due to its lower hardness.

Various processes have been developed to enable the non-slip hardening of circumferential surfaces of large annular components.

A first example of such a method is known from EP 1 848 833 B1. In this method for manufacturing a bearing ring for large-size rolling bearings with at least one race with a hardened surface layer, at least two inductors are arranged at the beginning of the hardening over a common initial zone of the annular race to be hardened and they heat the opposite surface layer there to hardening temperature. The inductors are then moved along the race in the opposite direction to heat the intermediate zones of the annular race of the bearing ring, which each adjoin the initial zone. After the inductors, which are moved in opposite directions, have covered a short distance, sprays directed at the heated surface layers are switched on so that the relevant previously heated surface layers are quenched proceeding from the middle of the initial zone heated at the beginning. The inductors and with them the respectively assigned spray are then moved further on their ring halves until they meet again at an end zone opposite the starting point and again form a common heating zone there. Once the required hardening temperature has been reached in the end zone, both inductors are lifted vertically off the surface of the race to make room for the sprays, which are now directed towards the end zone, in order to quench them. In order to bring the end zone to hardening temperature reliably and quickly, the known method provides for an additional auxiliary inductor, which preheats the end zone already during the heating of the initial zone or the intermediate zones.

A further method of the type in question here is known from EP 2 310 543 B1. This method is based on the older method described in EP 1 848 833 B1 and envisages the auxiliary inductor, which is used in the method known from EP 1 848 833 B1 for preheating the end zone, being moved, for example in an oscillating or circular manner, to homogenize the heating in an additional degree of freedom compared to the movements already provided for in the older method.

A third method for hardening a workpiece plotting a closed curved line, such as a bearing or toothed ring, is known from EP 1 977 020 B1. In this known method, at least two inductors are placed on the workpiece in a starting region in a first work step, wherein the inductors adopt start positions closely adjacent to one another which delimit a starting zone between them. The starting zone is then heated to hardening temperature by means of at least one of the inductors and subsequently quenched. The inductors are then moved along the workpiece proceeding from their respective start position, wherein the direction of movement of one inductor is directed opposite to the direction of movement of the other inductor and wherein the sections of the workpiece located in the operating region of the inductors are heated to hardening temperature and subsequently quenched. The opposite movements of the inductors are continued until the inductors have reached an end position in which they are arranged closely adjacent to the respectively other inductor in each case. An end zone is now enclosed between the end positions of the two inductors that is then reached. In order to also bring this end zone to hardening temperature, the inductors are moved together in the direction of one of the directions of movement of the inductors and the end zone is heated to hardening temperature by the inductor that has already been previously moved in this direction of movement. In this way, the end zone is completely traversed by at least one of the inductors and brought uniformly to hardening temperature.

Finally, a method and a device for the inductive hardening of an annular surface of a circular component are known from EP 2 542 707 B1, in the case of which four inductors are arranged grouped into two inductor pairs on the annular surface to be hardened, wherein a spray is assigned to each inductor pair and at the beginning of the heating, the sprays are arranged closely adjacent to one another. The inductors of the inductor pairs and the assigned sprays are also arranged directly next to each other. After being switched on, the inductor-spray combinations aligned over an initial zone of the race to be hardened are moved in opposite circumferential directions along the intermediate section, assigned to them in each case, of the race to be hardened such that the surface sections previously heated to hardening temperature by means of the inductor pairs are subsequently immediately quenched in order to form hardening structures on the surface layer of the race. The inductor pairs continue their opposing movement until the respectively leading inductors of the inductor pairs meet over an end zone of the race. When the end zone is reached, the leading inductors are removed from the race surface in order to make room for the trailing inductors of the inductor pairs. These trailing inductors continue to be moved in their respective previous circumferential direction until they also meet above the end zone and the end zone is also heated to hardening temperature by the two trailing inductors. After the trailing inductors have also been moved successively or simultaneously away from the end zone of the surface to be hardened together with the spray assigned to each of them, the end zone is also quenched by a further spray in order to also achieve hardening structures there.

### SUMMARY OF THE INVENTION

Against the background of the prior art explained above, the object has emerged to provide a method optimised in terms of the time required, which makes it possible to surface layer harden a circumferential surface of an annular component optimally uniformly and without interruptions.

The invention proposes a method for achieving this object in which at least the work steps indicated in claim 1 are completed.

It goes without saying that a person skilled in the art, in carrying out the method according to the invention and its variants and expansion options explained here, supplements the work steps not explicitly mentioned in the present case, which he knows from his practical experience are regularly applied when carrying out such methods.

Advantageous embodiments of the invention are defined in the dependent claims and, like the general concept of the invention, are explained in detail in the following.

The method according to the invention is thus used for the inductive surface layer hardening of a surface which runs around an annular component consisting of a hardenable steel and which comprises an initial zone, two intermediate zones, of which the first intermediate zone is connected to the initial zone in a first circumferential direction and of which the second intermediate zone is connected to the initial zone in a second circumferential direction opposite to the first circumferential direction, and an end zone which extends between the ends of the intermediate zones facing away from the initial zone.

In this case, the following work steps are carried out in the course of the method according to the invention in accordance with the prior art explained at the outset:
a) surface layer hardening of the initial zone by the initial zone being brought to hardening temperature by means of at least one inductor and being quenched by means of at least one spray, which directs a jet of a quenching medium onto the heated initial zone,
b) successive surface layer hardening of the intermediate zones subsequent to the surface layer hardening of the initial zone, in each case by an inductor arrangement which is moved, proceeding from a starting region of the respective intermediate zone adjoining the initial zone, along this intermediate zone to the end zone, wherein each inductor arrangement comprises a leading inductor which causes preheating of the region of the intermediate zone respectively covered by it, a trailing inductor, which is arranged relative to the leading inductor in the direction of the initial zone and causes finish-heating of the region previously preheated by the leading inductor to hardening temperature, as well as a spray, which quenches, using a jet of a quenching medium, the region previously finish-heated in each case by the trailing inductor,
c) surface layer hardening of the end zone subsequent to the surface layer hardening of the intermediate zones, by at least one of the trailing inductors of the inductor arrangements that reached the end zone heating the end zone to hardening temperature and the end zone being quenched by means of a spray, which, after heating, directs a jet of a quenching medium towards the end zone.

According to the invention, after the inductor arrangements in work step b) are located at a certain distance from the initial zone, the leading inductor of at least one of the inductor arrangements is now moved at least temporarily in the direction of the end zone at an increased feed rate compared to the trailing inductor of this inductor arrangement such that an enlarged distance results between the leading inductor and the trailing inductor and the leading inductor reaches the end zone by a time interval earlier, whose duration is equal to the duration required by the trailing inductor to overcome the distance previously resulted between it and the leading inductor. The at least one leading inductor arriving first at the end zone then preheats the end zone until at least one of the trailing inductors of the inductor arrangements has arrived in the end zone and finish-heats the end zone to hardening temperature.

In the case of the method according to the invention, the preheating of the end zone of the surface to be surface layer hardened takes place by means of one of the inductors, which are already involved in the surface layer hardening of the intermediate zones of the surface carried out in circulation. For this purpose, two inductor arrangements with two inductors each and a spray are used, which together plot an opposing circular route over the intermediate zones after a starting phase.

In this case, the inductors of the inductor arrangements arranged closely adjacent at the beginning for example, but not necessarily, are initially moved along the intermediate zones at the same speed until the inductor arrangements have covered a certain distance proceeding from the starting region of the intermediate zones adjoining the initially hardened initial zone and are accordingly located at a certain distance from the end zone.

If this point is reached, at least one of the front, i.e. leading, inductors of the inductor arrangements seen in the respective feed direction accelerates such that it is separated from the trailing inductor of its inductor arrangement assigned to it and moves in the direction of the end zone at increased speed. Even in this phase, the now faster-moving leading inductor continues to function, i.e. it also preheats the regions of the intermediate zone during its fast movement, which are covered by the electromagnetic field induced by it in each case.

As a result of its higher feed rate, the leading inductor reaches the end zone of the surface more quickly such that it can already preheat it as long as the trailing inductor of its inductor arrangement is still on its way to the end zone. Once the trailing inductor has arrived at the end zone, the leading inductor is moved away from the end zone and the trailing inductor replaces it in order to finish-heat the end zone to hardening temperature. Once the end zone has reached the hardening temperature, the trailing inductor is also removed from the end zone and the end zone is quenched by means of the spray provided for this purpose.

In principle, it may be sufficient for the sprays used according to the invention to direct a single jet of the quenching medium to the zone to be quenched in each case, provided that this jet is sufficiently strong and the applied liquid volume is sufficiently large to remove heat from the zone to be hardened at the required speed. In practice, sprays, which simultaneously apply a plurality of individual jets, have proven themselves for this purpose in order to safely and completely apply to the zone to be quenched a quantity of quenching medium that is sufficient to remove the heat.

While the leading inductor of one inductor arrangement is moved at increased speed, the inductors of the second inductor arrangement can continue to be moved unchanged at their original feed rate. In this case, the leading inductor of the second inductor arrangement is also moved slower than the faster-running inductor of the first inductor arrangement and therefore reaches the end zone later. In order not to disturb the leading inductor already preheating the end zone, the leading inductor of the second inductor arrangement can be moved away from the surface to be surface layer hardened into a waiting position when the end region, adjoining the end zone, of the intermediate zone assigned to it is reached such that the trailing inductor of the second inductor arrangement can be moved into this end region and the intermediate zone can be finish-heated.

Just like preheating by means of only one of the leading inductors in each case, finish-heating of the end zone can also be carried out by means of only one of the trailing inductors in each case. In this variant, the trailing inductor of the inductor arrangements, which is not used for the finish-heating of the end zone, is moved away from the surface to be surface layer hardened to a waiting position after it has reached the end region, adjoining the end zone, of the intermediate zone assigned to it and has heated said end region to hardening temperature.

One advantage of the preheating and/or finish-heating of the end zone with only one inductor in each case is that mutual disturbances of the respectively effective electromagnetic field, which can occur if two inductors closely adjacent heat a zone together, do not occur. Special measures to avoid these disturbances are therefore not necessary. In addition, the use of a single inductor for the preheating and/or finish-heating of the end zone allows precise control of the heat introduced into the end zone such that, for example, a correspondingly precisely designed hardness profile can be achieved in the hardened surface layer.

As an alternative to the variants explained above, in which the preheating and finish-heating of the end zone has only been carried out with one inductor in each case, it is also possible, in cases in which for example the heating to hardening temperature is to be achieved as quickly as possible, to carry out the preheating and/or finish-heating in each case by means of two inductors together.

In order to enable common preheating of the end zone by means of the two leading inductors of the inductor arrangements, both leading inductors of the inductor arrangements can be moved forwards more quickly in the manner described above as soon as the distance to the initial zone provided as the starting point for the faster movement is reached. As a result, both leading inductors, ideally at the same time, reach the end zone and preheat it until the trailing inductors of their inductor arrangements also reach the end zone. When this state is reached, both leading inductors are removed from the end zone in order to make room for the individual trailing inductor provided for finish-heating or the two trailing inductors of the inductor arrangements if they are to carry out finish-heating together.

In practice, the difference in speed between the leading inductor moved at increased feed rate and the trailing inductor assigned to it is, for example, set such that the duration available for the preheating of the end zone by means of the leading inductor is 1-10 s.

In practice, suitable increased feed rates of the leading inductors are, for example, in the range of 240-1800 mm/min, whereas the feed rates at which the trailing inductors and temporarily also the leading inductors are moved along the intermediate zones can be in the range of 180-1200 mm/min. It goes without saying that the respective speed is selected within the ranges specified for the increased feed rate of the leading inductors and the feed rate of the trailing inductors such that the increased feed rate of the leading inductors is higher than the speed at which the trailing inductors are moved.

In practice, the distance measured proceeding from the start position from which the faster feed movement of the respectively leading inductor starts to the beginning of the end zone in the direction of the movement of the leading inductor can be 40-300 mm.

In this case, the difference in speed between the leading inductor moved at increased feed rate and the trailing inductor assigned to it is preferably set such that the duration available for the preheating of the end zone by means of the leading inductor is 1-10 s.

In order to ensure that the respective leading inductor also generates sufficient heat in the regions covered by it during the phase of its fast movement, it may be expedient for the electrical power of the inductor leading at increased feed rate to be increased compared to the electrical power with which the relevant leading inductor is operated as long as it is moved at the same feed rate as the trailing inductor of its inductor arrangement. It may also be expedient to adjust the power of the respective trailing inductor if the leading inductor assigned to it is moved at an increased feed rate in order to ensure a heat input sufficient for heating to hardening temperature.

In order to achieve heating of the end zone that is as uniform as possible, it may also be expedient for the inductor(s) used for the preheating and/or finish-heating to be moved in a manner known per se relative to the end zone during the heating process. This can for example take the form of an oscillating or rotational movement.

Even when heating the initial zone, it may be advantageous with regard to the targeted setting of a certain hardness profile if only one inductor is used. To this end, according to a further variant of the method according to the invention, in work step a), the heating of the initial zone to hardening temperature can practically be carried out by an inductor of one of the inductor arrangements. This results in a movement sequence of the inductors involved that is easy to implement in practice if the inductor used to heat the initial zone is a trailing inductor of one of the inductor arrangements provided according to the invention. In order to make room for the use of the spray in this case after heating the initial zone to hardening temperature, the trailing inductor used to heat the initial zone, after the initial zone is heated to hardening temperature, in particular suddenly, can be moved in the direction of the starting region of the intermediate zone assigned to its inductor arrangement such that the jet of the spray provided for quenching the initial zone can then be directed to the initial zone in the space freed up by the inductor moving away.

The spray used for quenching the initial zone can be a spray of one of the inductor arrangements. For this purpose, it can be provided that at least the spray used for this purpose can be moved independently of the inductors such that, in order to quench the initial zone, it can be moved from its spatial assignment to the inductors during normal hardening operation to an operating position in which its spray jet optimally meets the initial zone to be quenched. However, with a view to optimising the transition between the hardening of the initial zone and the hardening of the intermediate zones adjoining it, it may also be favourable if a separate spray is provided for quenching the initial zone, whose jet and power are specially adapted to the conditions prevailing in the region of the initial zone.

Similarly, at least one of the sprays carried with the inductor arrangements can be used for quenching the end zone. For this purpose, it can also be provided that the spray can be moved independently of the inductors of the respective inductor arrangement such that, in order to quench the end zone, it can be moved from its spatial assignment to the inductors of the respective inductor arrangement into an operating position in which its spray jet optimally meets the end zone to be quenched. Alternatively, however, it is also possible here to achieve an optimised quenching result with minimised effort for the adjustment of the sprays of the inductor arrangements by using an additional spray to quench the end zone, which is independent of the sprays of the inductor arrangements and is located in a waiting position during the heating of the end zone.

It can also contribute to the homogenisation of the result of the surface layer hardening if a rotational movement of the component directed in at least one of its circumferential directions overlays the feed movement of the inductor arrangements. This rotational movement can, for example, also be carried out in an oscillating manner.

### BRIEF DESCRIPTION OF THE DRAWINGS

The invention is explained in more detail below on the basis of a drawing representing an exemplary embodiment.

FIGS. 1-8 each show a device for surface layer hardening in different phases of the method according to the invention schematically and not to scale in plan view.

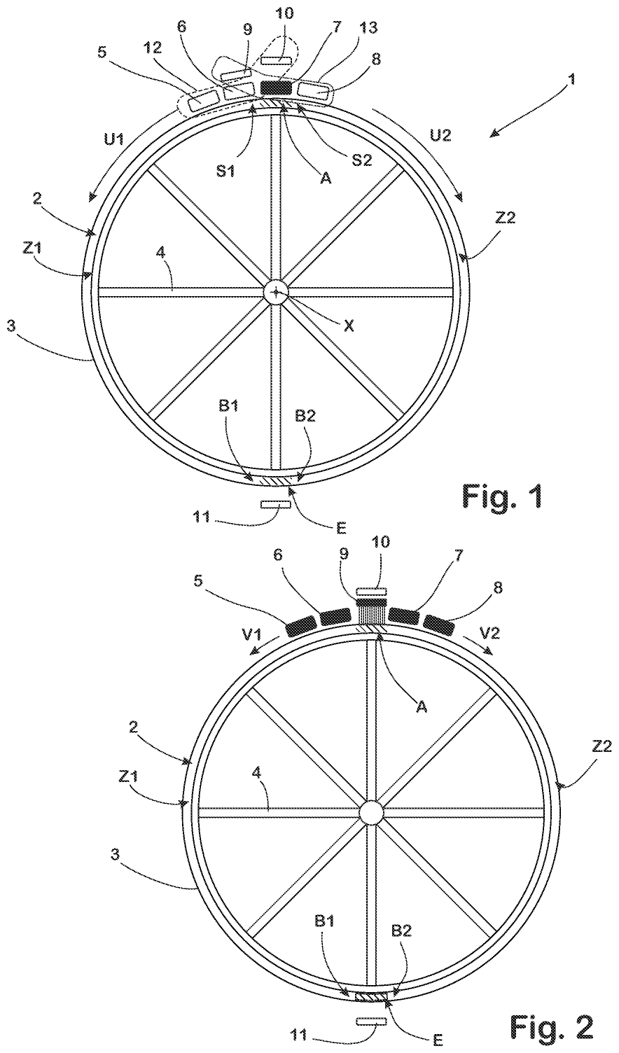

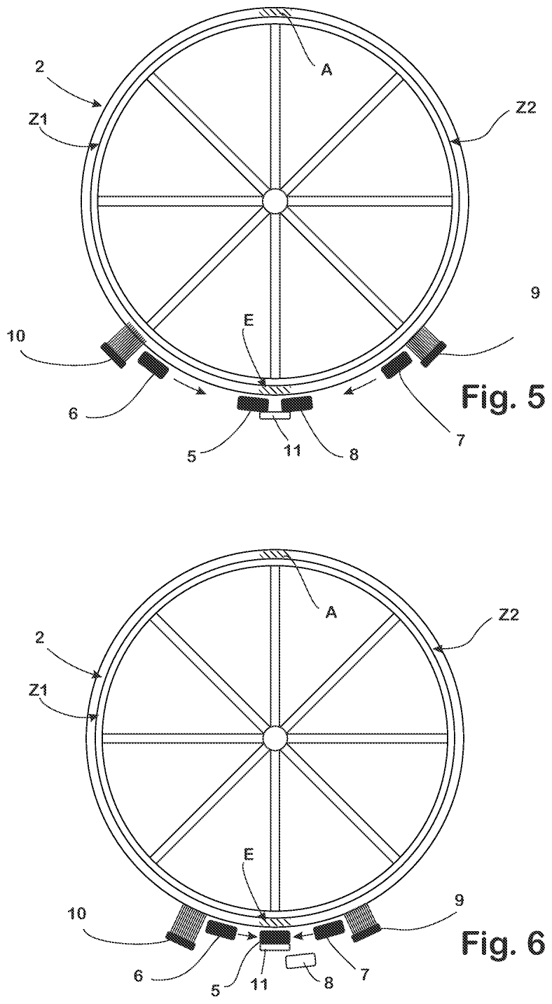

The device 1 represented in FIGS. 1-8 is for example used for the surface layer hardening of a race surface 2 which runs around the outer circumference of a bearing ring 3 for a large-size rolling bearing consisting of a suitable steel material known for this purpose.

For this purpose, the device 1 comprises a horizontally aligned workpiece holder 4, which can optionally be rotated about a central vertical axis X and in which the bearing ring 3 is clamped in a horizontal orientation.

The race surface 2 of the bearing ring 3 is composed without interruption of an initial zone A, two intermediate zones Z1, Z2, and an end zone E. The intermediate zones Z1, Z2 are each connected with their starting regions S1, S2 to an assigned edge of the initial zone A. The one intermediate zone Z1 thereby extends in a first circumferential direction U1 and the second intermediate zone Z2 extends in a circumferential direction U2 of the bearing ring opposite to the first circumferential direction U1. The end zone E extends between the end regions B1, B2 of the intermediate zones Z1, Z2 assigned to it and is arranged opposite the initial zone A here. While the intermediate zones Z1, Z2 each extend approximately over half of the arc plotted by the race surface 2, the initial zone A and the end zone E each occupy only one correspondingly short section of the circumferential length of the race surface 2 compared to the length of the intermediate zones.

The device 1 further comprises four inductors 5, 6, 7, 8, each of which are supported by actuating devices not shown here, which move the inductors 5-8 in all degrees of freedom required here.

The device 1 also comprises sprays 9, 10, 11, of which the sprays 9, 10 are also carried by actuating devices which move the sprays 9, 10 in the manner required here. In contrast, the spray 11 is arranged stationary in the vicinity of the end zone E of the race surface 2 of the bearing ring 3. It can be pivoted out of a waiting position, in which it is located outside the space in which the inductors 5-8 and the sprays 9, 10 move, to an operating position in which it directs jets of a suitable quenching medium known for these purposes towards the end zone E. The quenching medium can be, for example, water or an aqueous polymer solution.

In FIGS. 1-8, the inductors 5-8 and the sprays 9-11, which are switched on in the operating state represented in the respective figure, are represented as black-filled rectangles, while those inductors 5-8 and sprays 9-11, which are not switched on in the respective operating state, are represented as white-filled rectangles.

The inductors 5, 6 and the spray 10 together form a first inductor arrangement 12 indicated in FIG. 1 by a dashed border, while a second inductor arrangement 13 is formed by the inductors 7, 8 and the spray 9, which in FIG. 1 is indicated by a dot-dashed border.

### DESCRIPTION OF THE INVENTION

At the beginning of the surface layer hardening (FIG. 1) of the race surface 2, the inductor 7 of the second inductor arrangement 13 is positioned directly opposite the initial zone A and switched on in order to heat the initial zone A to the hardening temperature. The second inductor 8 of the inductor device 13 is simultaneously switched off in a waiting position in the circumferential direction U2 offset with respect to the inductor 8 above the starting region S2 of the intermediate zone Z2 directly adjoining the initial zone A.

The spray 10 of the inductor arrangement 12, which is also switched off, is offset in the radial direction and arranged behind the inductor 8 in relation to the bearing ring 3.

Inductors 5 and 6 and spray 9 are also switched off and are in a waiting position. Thus, the inductor 6 is arranged next-adjacent to the inductor 7 above the starting region S1 of the intermediate zone Z1, the inductor 5 is arranged offset to the inductor 6 in the circumferential direction U1 also above the starting zone S1 and the spray 9 is positioned behind the inductor 6 offset in the radial direction in relation to the bearing ring 3. The distance of the spray 9 to the bearing ring 3 is smaller than the distance of the spray 10 to the bearing ring 3. In this way, the sprays 9 and 10 can be moved past one another in the respective circumferential direction U1, U2 without colliding.

In the case of the inductor arrangement 12, in relation to a movement in the circumferential direction U1, the inductor 5 is therefore a leading inductor in relation to the inductor 6 and the inductor 6 is a trailing inductor in relation to the inductor 5. In contrast, in the case of the inductor arrangement 13, in relation to a movement in the circumferential direction U2, the inductor 8 is a leading inductor in relation to the inductor 7 and the inductor 7 is a trailing inductor in relation to the leading inductor 8.

As soon as the initial zone A is heated to hardening temperature (FIG. 2), the inductors 7 and 8 and with it the assigned spray 9 are moved suddenly and rapidly in the circumferential direction U1 along the intermediate zone Z2 such that the trailing inductor 8 frees up the space previously occupied by it at the initial zone A and the spray 9 is located opposite the initial zone A. It is situated in this position between the bearing ring 3 and the spray 10 of the inductor arrangement 12. The spray 9 now directs a jet of the quenching medium onto the initial zone A such that said initial zone A is quenched by forming hardening structures in a surface layer adjoining the race surface 2. At the same time, the inductors 5, 6, 7, 8 of the inductor arrangements 12, 13 are switched on and moved along the respectively assigned intermediate zone Z1, Z2 at a continuous feed rate V1, V2 (V1=V2). The respectively leading inductors 5, 8 each carry out preheating of the regions covered by their electromagnetic field, whereas the respectively trailing inductors 6, 7 heat up the previously preheated regions of the intermediate zones Z1, Z2 to hardening temperature.

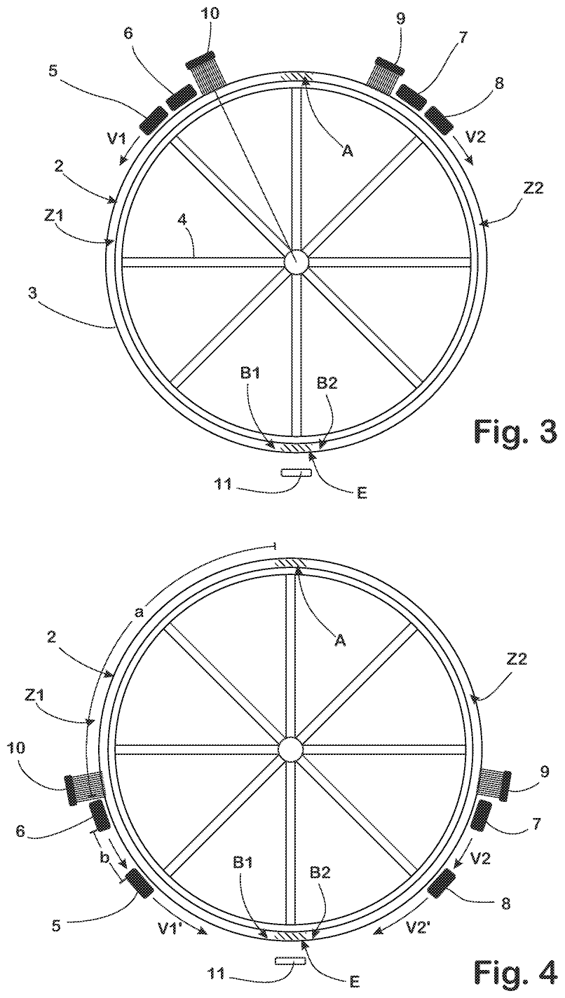

The trailing inductors 6, 7 are followed by the respectively assigned spray 9, 10, which direct the quenching media towards the regions of the intermediate zones Z1, Z2 previously heated to hardening temperature and quench them by forming hardening structures in the respective region of the surface layer (FIG. 3).

In order to keep the inductors 5-8 in each case in tangential orientation and at a constant distance from the race surface 2, the inductor arrangements 12, 13 are moved in a manner known per se not only in the horizontal plane along the bearing ring 3, but also additionally rotated about a vertical axis.

As soon as the inductor arrangements 12, 13 are each located at a certain distance a from the initial zone A, which corresponds, for example, to 60%, 70%, 80% or 90% of the length of the intermediate zones Z1, Z2 measured in the circumferential direction, the leading inductors 5, 8 of the inductor arrangements 12, 13 are moved at increased speed V1′, V2′ (V1′=V2′) in the direction of the end zone E along the respectively assigned intermediate zone Z1, Z2. The trailing inductors 6, 7, on the other hand, continue to be moved at the feed rate V1, V2 with the sprays respectively assigned to them. As a result, the distance b between the trailing and the leading inductors 5, 6 and 7, 8 of the inductor arrangements 12, 13 is enlarged continuously until the leading inductors 5, 8 reach the end zone E (FIG. 4, 5).

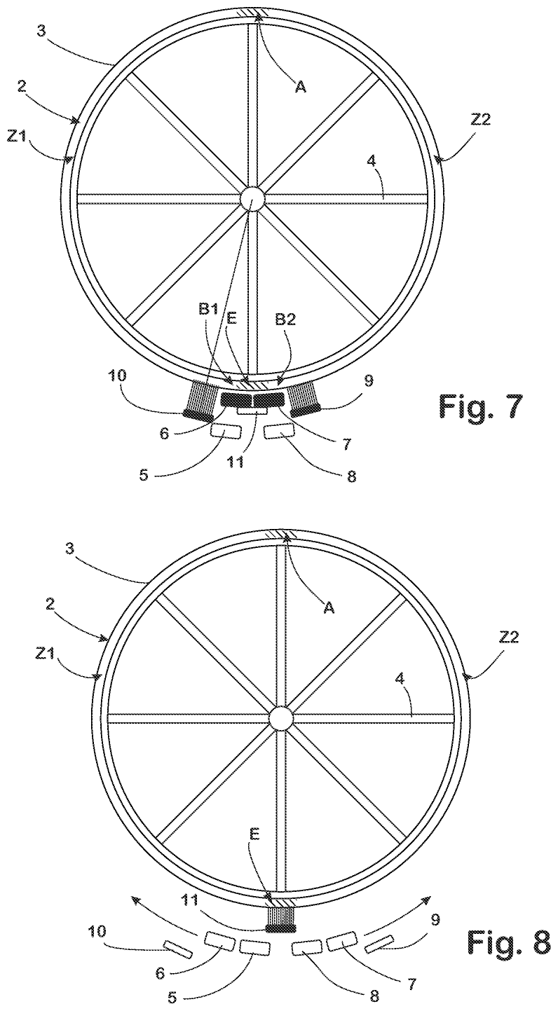

The leading inductor 8 of the inductor arrangement 13 is now switched off and moved to a waiting position. At the same time, the leading inductor 5 of the inductor arrangement 12 is positioned centrally over the end zone E and starts with the preheating of the end zone E (FIG. 6). This preheating is continued until the trailing inductors 6, 7 reach the end regions B1, B2 of the intermediate zones Z1, Z2. As soon as this has occurred, the leading inductor 5 arranged above the end zone E is switched off and moved to a waiting position. As a result, the trailing inductors 6, 7 are arranged together above the end zone E so that they together heat the end zone E to hardening temperature. Meanwhile, the sprays 9, 10 quench the end regions B1, B2 of the intermediate zones (FIG. 7). Alternatively, it would also be possible to switch off one of the trailing inductors and to also move it to a waiting position and use only the other trailing inductor to heat up the end zone E to hardening temperature.

When end zone E is heated to hardening temperature, the trailing inductors 6, 7 are also removed from the end zone E, switched off and moved to a waiting position. The sprays 9, 10 are also switched off and moved to a waiting position. The end zone E is quenched using the spray 11 which, after the trailing inductors 6, 7 have been removed from the end zone E, is pivoted into the space freed up as a result. Proceeding from their waiting positions, the leading and trailing inductors 5, 6; 7, 8 and sprays 9; 10 belonging to the respective inductor arrangement 12; 13 are returned to their initial positions shown in FIG. 1. The slip-free surface layer hardening of the race surface 2 is thus completed.

The invention thus provides a method for the inductive surface layer hardening of a surface running around an annular component, which is composed of an initial zone, an end zone and two intermediate zones extending between the initial and end zone. The initial zone is brought to hardening temperature by an inductor and quenched by a spray. Subsequently, an inductor arrangement is moved in each case along the intermediate zone up to the end zone E. Each inductor arrangement comprises a leading inductor for preheating the region covered by it, a trailing inductor for finish-heating the preheated region and a spray for quenching the finish-heated region. After the inductor arrangements are located at a certain distance from the initial zone, according to the invention, the leading inductor of at least one of the inductor arrangements is moved in the direction of the end zone at an increased feed rate compared to the trailing inductor. The leading inductor thus reaches the end zone by a time interval earlier, whose duration is equal to the duration required by the trailing inductor to overcome the distance previously resulted between said trailing inductor and the leading inductor. In the meantime, the end zone is preheated by the respectively leading inductor, which reached to the end zone with a time advantage over the trailing inductor assigned to it. When one of the trailing inductors of the inductor arrangements has arrived in the end zone, it finish-heats the end zone to hardening temperature.

### REFERENCE NUMERALS

1 Device for the surface layer hardening of the race surface 2
2 Race surface of the bearing ring 3
3 Bearing ring
4 Workpiece holder
5, 8 Leading inductors
6, 7 Trailing inductors
9, 10 Moving sprays
11 Stationary spray
12 First inductor arrangement comprising the leading inductor 5, the trailing inductor 6 and the spray 10
13 Second inductor arrangement comprising the leading inductor 8, the trailing inductor 7 and the spray 9
a Distance between the inductor units 12, 13 and the initial zone A
b Distance between the trailing inductors 6, 7 and the leading inductors 5, 8 of the inductor units 12, 13
A Initial zone of the race surface 2
B1, B2 End regions of the intermediate zones Z1, Z2
E End zone of the bearing surface 2
S1, S2 Starting regions of the respective intermediate zones Z1, Z2
U1 First circumferential direction
U2 Circumferential direction opposite the first circumferential direction U1
V1, V2 Feed rates
V1′, V2′ Increased feed rates
X Vertical axis of the workpiece holder 4
Z1, Z2 Intermediate zones of the race surface 2

1. A method for the inductive surface layer hardening of a surface which runs around an annular component consisting of a hardenable steel and which comprises an initial zone, two intermediate zones, of which the first intermediate zone is connected to the initial zone in a first circumferential direction and of which the second intermediate zone is connected to the initial zone in a second circumferential direction opposite to the first circumferential direction, and an end zone which extends between the ends of the intermediate zones facing away from the initial zone, comprising the following work steps:
a) surface layer hardening of the initial zone by the initial zone being brought to hardening temperature by means of at least one inductor and being quenched by means of at least one spray, which directs a jet of a quenching medium onto the heated initial zone,
b) successive surface layer hardening of the intermediate zones subsequent to the surface layer hardening of the initial zone, in each case by an inductor arrangement being moved, proceeding from a starting region of the respective intermediate zone adjoining the initial zone, along this intermediate zone to the end zone, wherein each inductor arrangement comprises a leading inductor, which causes preheating of the region of the intermediate zone respectively covered by it, a trailing inductor, which is arranged relative to the leading inductor in the direction of the initial zone and causes finish-heating of the region previously preheated by the leading inductor to hardening temperature, as well as a spray, which quenches, using a jet of a quenching medium, the region previously finish-heated in each case by the trailing inductor,
) surface layer hardening of the end zone subsequent to the surface layer hardening of the intermediate zones, by at least one of the trailing inductors of the inductor arrangements that reached the end zone heating the end zone to hardening temperature and the end zone being quenched by means of a spray, which, after heating, directs a jet of a quenching medium towards the end zone,
wherein,
after the inductor arrangements in work step b) are located at a certain distance from the initial zone, the leading inductor of at least one of the inductor arrangements is moved at least temporarily in the direction of the end zone at an increased feed rate compared to the trailing inductor of this inductor arrangement such that an enlarged distance results between the leading inductor and the trailing inductor and the leading inductor reaches the end zone by a time interval earlier, whose duration is equal to the duration required by the trailing inductor to cover the distance previously resulted between the trailing inductor and the leading inductor,
that the at least one leading inductor arriving first at the end zone preheats the end zone until at least one of the trailing inductors of the inductor arrangements has arrived in the end zone and finish-heats the end zone to hardening temperature.

2. The method according to claim 1, wherein the electrical power of the inductor leading at increased feed rate is increased compared to the electrical power with which the relevant leading inductor is operated as long as it is moved at the same feed rate as the trailing inductor of its inductor arrangement.

3. The method according to claim 1, wherein the electrical power of the trailing inductor is increased compared to the electrical power with which the relevant trailing inductor is operated as soon as the leading inductor is moved at increased feed rate.

4. The method according to claim 1, wherein, in the work step a), the heating of the initial zone to hardening temperature is carried out by an inductor of one of the inductor arrangements.

5. The method according to claim 4, wherein the inductor is one of the trailing inductors.

6. The method according to claim 5, wherein the trailing inductor, after the initial zone is heated to hardening temperature, is moved in the direction of the starting region of the intermediate zone assigned to its inductor arrangement and in that the jet of the spray provided for quenching the initial zone is then directed to the initial zone in the space freed up by the inductor moving away.

7. The method according to claim 1, wherein the leading inductors of both inductor arrangements are moved at least temporarily in the direction of the end zone at an increased feed rate compared to the trailing inductor of this inductor arrangement, after the inductor arrangements in work step b) are located at a certain distance from the initial zone.

8. The method according to claim 7, wherein the inductors leading at increased feed rate preheat the end zone together after they reach the end zone.

9. The method according to claim 7, wherein of the inductors leading at increased feed rate, after they reach the end zone, one is removed from the end zone, while the other preheats the end zone.

10. The method according to claim 1, wherein the end zone is finish-heated by the trailing inductors of the inductor arrangements together to hardening temperature.

11. The method according to claim 1, wherein an additional spray is used to quench the end zone, which is independent of the sprays of the inductor arrangements and is in a waiting position during the heating of the end zone.

12. The method according to claim 1, wherein the component is moved in a rotary manner during its surface layer hardening at least temporarily in at least one of its circumferential directions.

13. The method according to claim 1, wherein the inductor respectively provided for the preheating and/or finish-heating of the end zone is moved relative to the end zone during the preheating and/or finish-heating.

14. The method according to claim 1, wherein the increased feed rate of the leading inductors is 240-1800 mm/min.

15. The method according to claim 1, wherein the feed rate, at which the trailing inductors are moved along the intermediate zones, is 180-1200 mm/min.
